(19) United States
(12) Patent Application Publication
(10) Pub. No.: US 2002/0013142 A1
(43) Pub. Date: Jan. 31, 2002

(54) Information transmission and reception system and server apparatus

(76) Inventor: Akira Koto, Tokyo (JP)

Correspondence Address: LAW OFFICE OF JOHN A. GRIECCI, 2201 E. WILLOW ST, STE D, PMB 344, SIGNAL HILL, CA, 90806-2142, US

(21) Appl. No.: 09/858,199

(22) Filed: May 15, 2001

(30) Foreign Application Priority Data
May 18, 2000 (JP) 2000-147031

(51) Int. Cl. H04M 1/66

(52) U.S. Cl. 455/410; 455/435

(57) ABSTRACT

It is an object of the present invention to provide an information transmission and reception system and server apparatus which make it possible to realize the broadening of scope of utilization forms of information transmission and reception apparatuses, and facilitate the keeping of information data secrecy. An information transmission and reception system using portable phones as the information transmission and reception apparatus which performs the transmission and/or reception of information data via an ordinary telephone line in a predetermined area, wherein said system is characterized in that, in a limited area different from said predetermined area, it uses said portable phones as the information transmission and reception apparatus capable of performing the transmission and/or reception of information data.

### BACKGROUND OF THE INVENTION

1. Field of the Invention

The present invention generally relates to an information transmission and reception system using an information transmission and reception apparatus which is capable of transmitting and receiving information data in a predetermined area, and more particularly, is directed to a server apparatus which is usable for this system, etc.

2. Background Art

In recent years, portable phones capable of doing wireless telecommunication within the range of electric wave have been in widespread use. There exist a large number of companies managing the transmission and reception of information data using those portable phones, which have an exclusive right to a particular frequency band respectively, transmitting and receiving information data using the electric wave of this frequency band to establish telecommunications. Portable phones transmit and receive information data by weak electric wave, and are hardly capable of directly transmitting this weak electric wave to portable phones of parties at remote locations. Therefore, a plurality of base stations capable of once receiving weak electric wave carrying information data are dispersedly set up within a predetermined area to form a telecommunication network by connecting these base stations via the telecommunication line such as a communications satellite, ordinary telephone line, etc. and carry out the transmission and reception of information data via base stations located near each portable phone at the time of communication.

While conventional portable phones could handle a wide variety of information data contents and became very convenient for planning the collection of information and communication with other parties, they had such problems as that it was extremely difficult to cope with various forms and usages of communication which have been hitherto non-existing and unthinkable, because they use the public telephone line though different in the frequency band, and that information data are vulnerable to interceptions by others, because said information data are often transmitted/received via the telecommunication line, etc. available for the general public.

To solve these problems, the present invention aims at providing an information transmission and reception system and server apparatus, which make it possible to realize the expanded scope of utilization forms of information transmission and reception apparatus and facilitate the guard of information data secrecy.

### SUMMARY OF THE INVENTION

In view of the above-described problems, this invention provides the following constructions.

(1) An information transmission and reception system using portable phones as an information transmission and reception apparatus which performs the transmission and reception of information data via an ordinary telephone line in a predetermined area, wherein said system employs said portable phones as an information terminal apparatus capable of transmitting and/or receiving information data exclusively used in a limited area different from said predetermined area.

(2) An information transmission and reception system using an information terminal apparatus capable of transmitting and receiving information data by a communication network utilizing an ordinary telecommunication line in a predetermined area, wherein said system is provided with a server apparatus which transmits and/or receives information data for said information terminal apparatus located in a limited area different from said predetermined area via a telecommunication network for the exclusive use in said limited area which is different from said telecommunication network.

(3) An information transmission and reception system described in (2), wherein said system employs portable phones as said information terminal apparatus to make the communication connection with said server apparatus in said limited area using a number different from the telephone number used in said predetermined area.

(4) A server apparatus capable of transmitting and/or receiving information data via a telecommunication network using a telecommunication line in a predetermined area, and transmits and/or receives information data for information terminal apparatuses located in a limited area different from said predetermined area via a telecommunication network for the exclusive use for said limited area different from said telecommunication network.

(5) A server apparatus described in (4), wherein said server apparatus receives information data from a plurality of said information terminal apparatuses, respectively, to store and process them.

A limited area in this invention includes several cases where it is present in a predetermined area, partially present in a predetermined area, not present in a predetermined area at all, and so on.

A predetermined area in this invention refers to a telecommunication area where information data can be transmitted/received via ordinary telephone lines using information terminal apparatuses.

Telecommunication network for the exclusive use in the limited area in this invention is formed using either an ordinary telephone line, etc. in some cases or without using such a line in other cases. In the case where a telecommunication network is constructed for the exclusive use in the limited area using an ordinary telephone line, etc., an information terminal apparatus may be used as the apparatus exclusively for transmitting information data, which makes it possible, for example, to use input numbers comprising different digits and numerals in which telephone companies, etc. do not manage. And, in the case where a telecommunication network is formed for the exclusive use in the limited area without using ordinary telephone lines, etc., it is possible, for example, to provide the information terminal apparatus with functions for transmitting/receiving the electric wave in a frequency band different from that used in the predetermined area so that said apparatus transmits/receives information data utilizing the above-described electric wave in a different frequency band.

Storage processing in this invention refers to a processing for receiving information data from the information terminal apparatus and storing it, and, after information data is storage-processed, it becomes possible to perform the data processing such as retrieval and adding up of said information data.

### BRIEF DESCRIPTION OF DRAWINGS

FIG. 1 is a schematic diagram illustrating an information transmission and reception system in accordance with an embodiment of the present invention.

FIG. 2 is a functional block diagram illustrating a server apparatus in accordance with an embodiment of the present invention.

FIG. 3 is a functional block diagram illustrating a portable phone in accordance with an embodiment of the present invention.

FIG. 4 is a simplified perspective view illustrating configurations of a portable phone in accordance with an embodiment of the present invention.

FIG. 5 is a flow chart illustrating functions of each constitutive element in accordance with an embodiment of the present invention.

FIG. 6 is a summary describing contents of information data stored in a server apparatus in accordance with an embodiment of the present invention.

FIG. 7 is a configuration diagram of a modified example of this invention illustrating a plurality of server apparatuses connected by private lines, etc.

### DETAILED DESCRIPTION OF THE PREFERRED EMBODIMENT

In the following, embodiments of this invention will be described with reference to the drawings, but not limited to them.

An information transmission and reception system of this embodiment is the one using portable phones as the information transmission and reception apparatus transmitting/receiving information data in voice, etc. via the ordinary telephone line used as the telecommunication line in a predetermined area, wherein a server apparatus is installed in such a limited area as a preparatory school campus with clustered school buildings, so that portable phones capable of communicating via the generally used public telephone line can be utilized as a temporary terminal apparatus for answering questionnaires in the limited area such as this preparatory school.

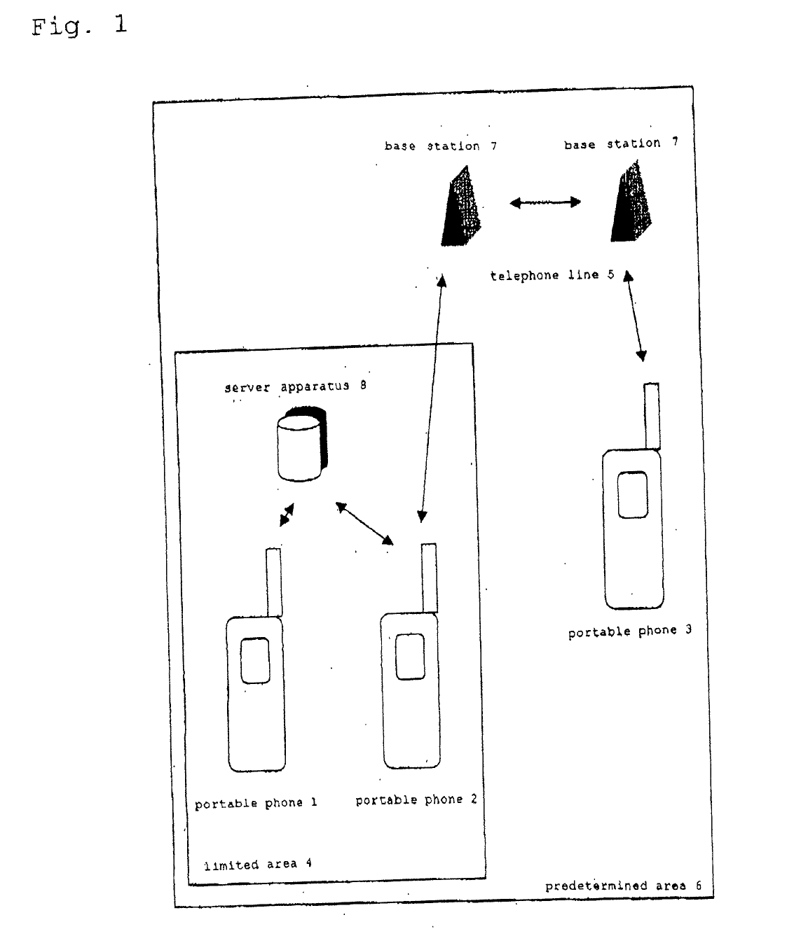

FIG. 1 is a schematic diagram illustrating an information transmission and reception system in accordance with an embodiment of the present invention.

In FIG. 1, numerals 1, 2 and 3 are portable phones which are kept by users. Portable phones 1 and 2 are located in a limited area 4, and a portable phone 3 is located in a predetermined area 6 which can be communicated by a wireless telephone line 5 using electric wave having a pre-selected frequency band. In this predetermined area 6 are dispersedly set up base stations 7s respectively, which make it possible to communicate by transmitting/receiving information data via base stations 7s located near each of portable phones 2 and 3.

In this figure, numeral 8 designates a server apparatus. This server apparatus 8 is set up in the limited area 4, i.e. a preparatory school building, so that it can receive information data from portable phones 1 and 2 located in the limited area 4 using the ordinary telephone line 5 used also in the predetermined area 6. As a result, in the limited area 4 is formed a telecommunication network for the exclusive use in the limited area 4, which is different from that formed in the predetermined area 6.

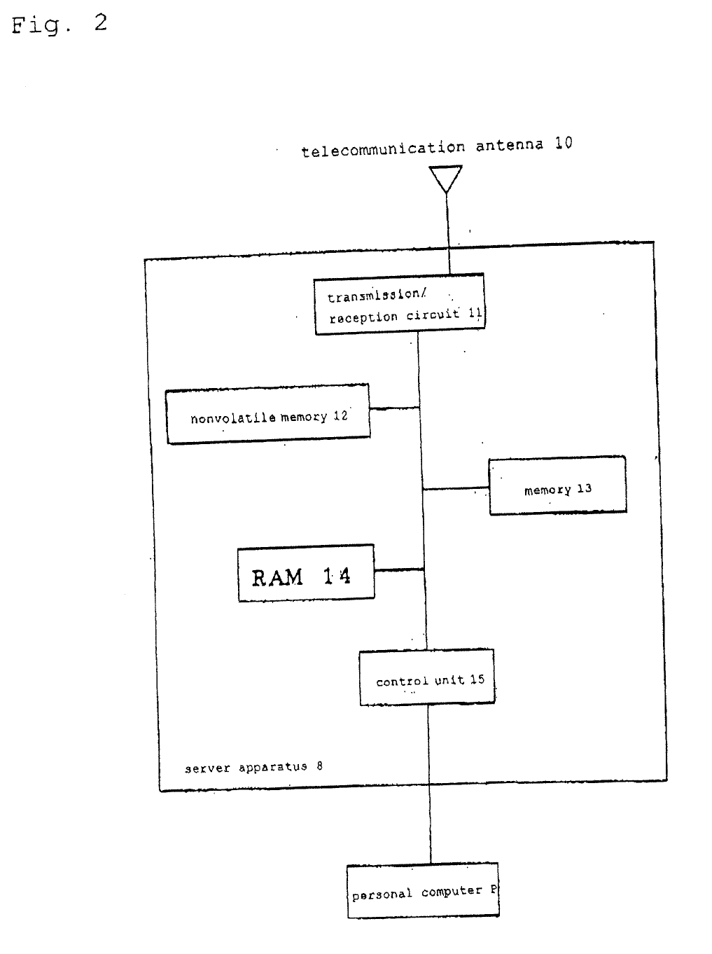

FIG. 2 is a functional block diagram illustrating a server apparatus 8 in accordance with an embodiment of the present invention. The server apparatus 8 manages the address number in which each of portable phones 1 and 2 possesses, and the information data corresponding to each address number, etc.

The server apparatus 8 is connected with a personal computer P, which can be operated by a manager on the preparatory school side, and set up so that said manager is able to retrieve or add up the information data received by each of portable phones 1 and 2 via said personal computer P. In addition, transmission/reception of the information data for each of portable phones 1 and 2 in the limited area 4 is carried out via the telecommunication antenna 10. The server apparatus 8 is provided with a transmission/reception circuit 11 connected with the telecommunication antenna 10, a nonvolatile memory 12 which once stores the information data transmitted from each of portable phones 1 and 2 and various items input from the personal computer P by the manager, a memory 13 comprising ROM, etc. for storing a program, etc. concerning the implementation of said functions in the server apparatus 8, RAM 14 having a working area wherein said program is carried out, and, in addition to them, a control unit 15 for directing the implementation of said program. As to the memory 13, in order to appropriately alter contents thereof, it is possible to provide the server apparatus 8 with external memory media such as CD-ROM and floppy disk which can be easily attached and removed.

In this embodiment, the server apparatus 8 is provided only with the function to receive the information data from each of portable phones 1 and 2, but may be provided also with a function to transmit the information data to each of said portable phones 1 and 2. In this case, an ordinary telephone line which can be used in the predetermined area 6 may be utilized to provide a transmission circuit for transmitting, for example, the information data concerning contents of examination questions and questionnaires to each of said portable phones 1 and 2. Furthermore, for an easy replacement of contents of said information data, it is also possible to store these information data in memory media such as CD-ROM, floppy disk, etc. of a structure which can be easily attached and removed.

Also, in this embodiment, transmission hindrance between other portable phones in the predetermined area 6 is prevented by forming a telecommunication network in the limited area 4 using an ordinary telephone line, and employing different digits and telephone numbers in which said ordinary telephone line does not use. In this invention, it is also possible to set up by forming an independent telecommunication network in the limited area 4 without employing the telephone line 5 used in the predetermined area 6 so that transmission and/or reception of information data can be performed for each of portable phones 1 and 2. In this case, it is also possible to use a method, wherein the communication connection is established with the server apparatus 8 by, for example, doing the transmission/reception of information data in a frequency band different from the one used in the predetermined area 6.

Furthermore, in the server apparatus 8, as described below, it is possible to receive information data from a plurality of said information terminal apparatuses respectively, and store and process these information data.

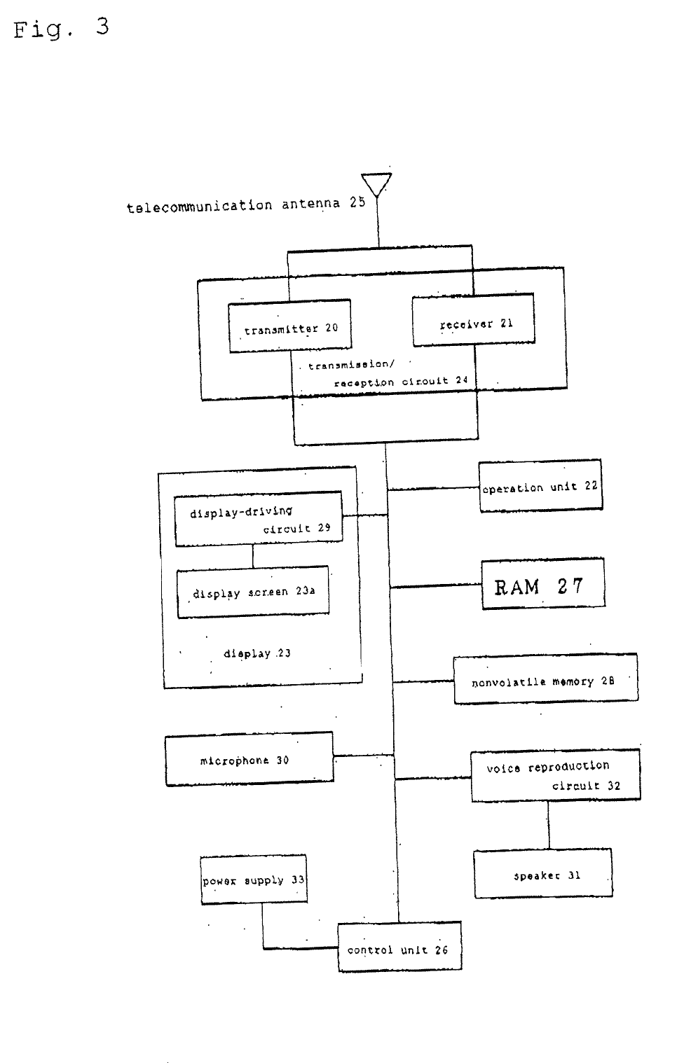

Next, functions of each portable phone will be described with reference to the portable phone 2. FIG. 3 is a functional block diagram of a portable phone in accordance with an embodiment of the present invention.

A portable phone 2 is provided with a transmitter 20 for transmitting information data to a portable phone 3, receiver 21 for receiving information data transmitted from said portable phone 3, a plurality of operating buttons as an operator 22 in which a user can manually operate for starting electric power supply 33 and inputting communication partner's telephone number as well as various inputs as described below and a display 23 for displaying information data received by a receiver 21 and input by the operation of the operator 22. The transmitter 20 and receiver 21 are provided with a conventionally used transmission/reception circuit 24 to transmit/receive the electric wave having a predetermined frequency as the communication data via a telecommunication antenna 25 as described below, and there can be performed the data conversion between this communication data form and the form which can be processed within portable phone on said transmission/reception circuit 24.

In addition, the portable phone 2 comprises a CPU as the control unit 26 for processing and controlling the transmission-reception of data, RAM 27 as the working area to process data based on the instruction of said control unit 26, a nonvolatile memory 28 for storing transmitted/received data, a display driving circuit 29 for driving the display of image on a display screen 23a based on the transmitted/received data, telecommunication antenna 25 as the window for accepting transmission of information data from other users, microphone 30 for inputting the voice of user, loudspeaker 31 for letting the user's voice out, voice reproduction circuit 32 for controlling the voice reproduction of loudspeaker 31, and electric power supply 33 for charging the voltage on these constitutive elements.

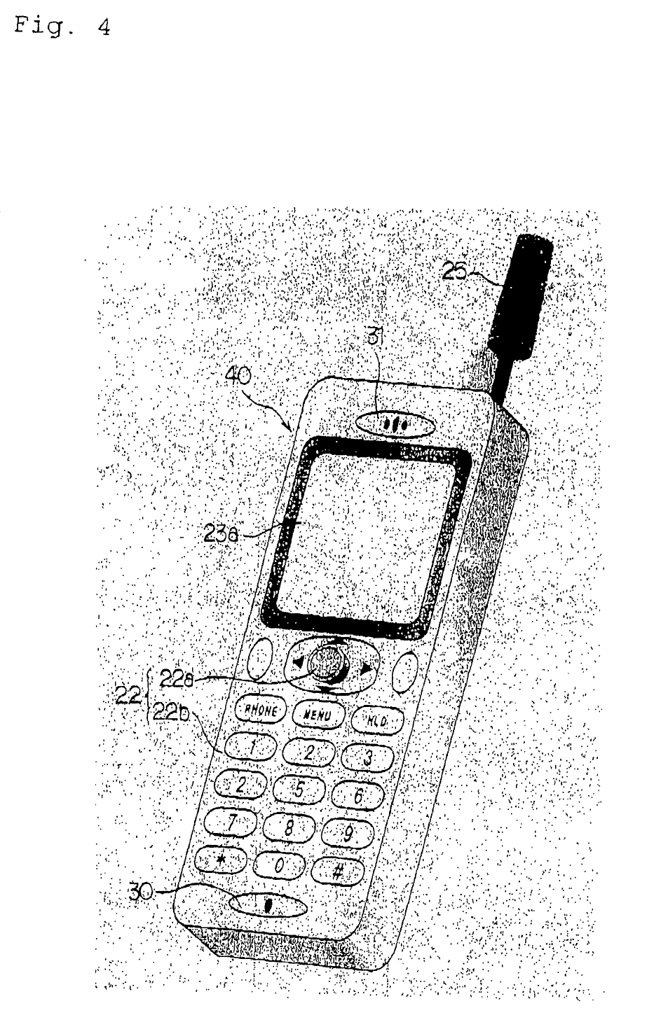

Next, the structure of portable phone in this invention will be described with reference to a simplified perspective view shown in FIG. 4.

A portable phone includes the above-described constitutive elements in a rectangular parallelopiped-formed main body 40 consisting of upper and lower fitting parts, and is provided with a telecommunication antenna 25 which can be freely extended and shortened on the upper end surface of the main body 40, and a loudspeaker 31, image display screen 23a, operation unit 22 and mnicrophone 30 in this order from the upper end to the lower end on the surface of the main body 40. In addition, though not shown in this figure, the main body 40 internally includes a substrate carrying the above-described constitutive elements, namely, a control unit 26, RAM 27, nonvolatile memory 28, display driving circuit 29 and voice reproduction circuit 32. The operation unit 22 is provided with a series of operating buttons corresponding to various input operations which make it possible to start the power supply 33, and instruct the input of telephone numbers of other users and transmission of each data, comprising a control unit 22a having input points of contact in 4 or 8 directions and a plurality of operating buttons 22b. The operating method is set up so as to be carried out according to a predetermined program previously stored in the nonvolatile memory 28.

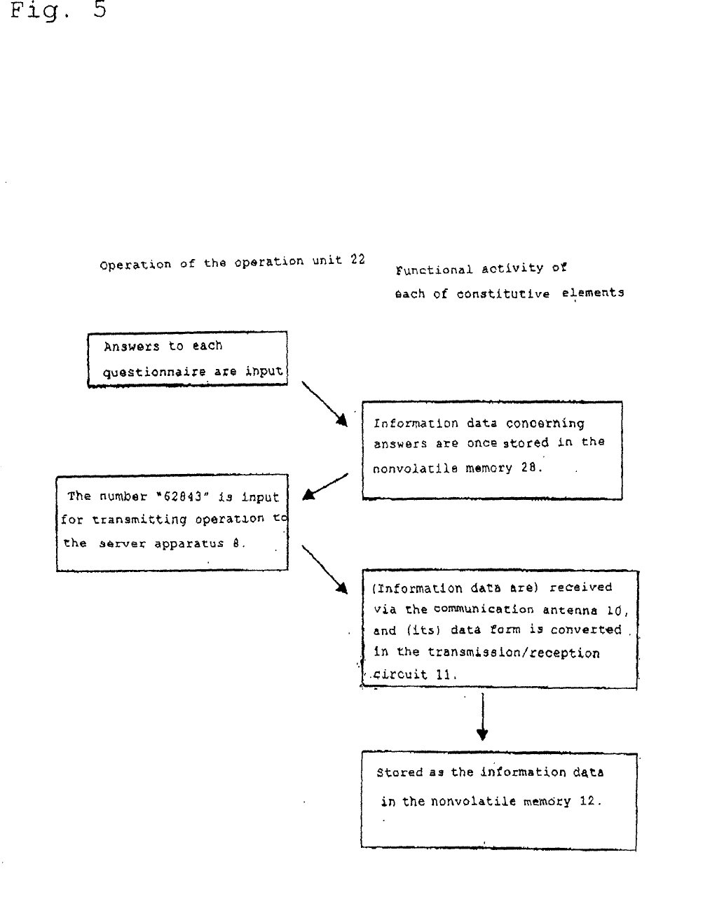

Next, functions of each of constitutive elements at the time of exchange of information data using portable phones 1 and 2 as well as the server apparatus 8 in the limited area 4 in the aforesaid present embodiment will be described with reference to a simplified flowchart in FIG. 5.

First, each of questionnaires distributed beforehand is to be answered. Answers to each questionnaire are described in a divided form, for example, from a) through e), out of which a correct answer is to be selected. Then, student inputs answers for every questionnaire by operating the control unit 22 using the portable phone 2. Information data on answers thus input are once stored in the nonvolatile memory 28, Then the student inputs a previously informed number “62843” for the communication connection with the server apparatus 8 to establish said communication connection with said server apparatus 8 by the electric wave in the same frequency band as that used in the telephone line 5. Then, by the operation of the operation unit 22 by student, information data concerning answers stored in the nonvolatile memory 28 are transmitted to the server apparatus 8. Since the number “62843” herein input is of digits and numerals which are not used in the ordinary telephone line 5, it hardly causes electric wave hindrance such as interference with busy portable phones.

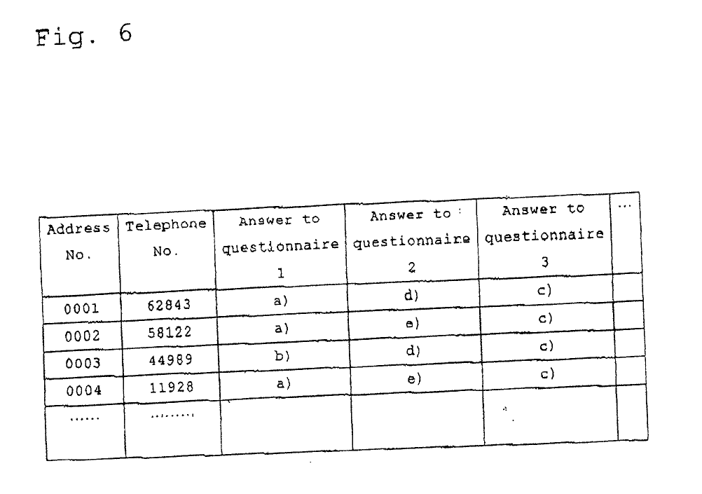

Furthermore, information data concerning answers transmitted from portable phones are once stored in the server apparatus 8. Thus, information data concerning answers collected from each portable phone are received via the telecommunication antenna 10, converted from data in the communication form to that in the form which can be internally processed by the transmission/reception circuit 11 of the server apparatus 8, and stored in the nonvolatile memory 12 one after another. FIG. 6 is a table summarized for describing contents of information data accumulated in the nonvolatile memory 12 of the server apparatus 8 in the present embodiment. Information data include contents concerning answers and address numbers assigned to each of transmitting portable phones for their recognitions, which are stored in the nonvolatile memory 12 in a state cassetted by the control of the control unit 14. Since information data concerning answers are stored in a state corresponding to each questionnaire with address numbers of portable phones attached, it becomes very easy for the preparatory school side to retrieve, add up and process accumulated information data using personal computer connected to the server apparatus 8. Thus, by employing the information transmission and reception system of this invention which makes it possible to transmit/receive only in the limited area 4, it becomes possible for a preparatory school side to not only transmit/receive information data, which might affect someone's privacy and are not wanted to be revealed to outsiders, without being intercepted in a closed area but also utilize generally used portable phones as temporary information terminals for the exclusive use in the preparatory school, leading to a great expansion of usage of portable phones.

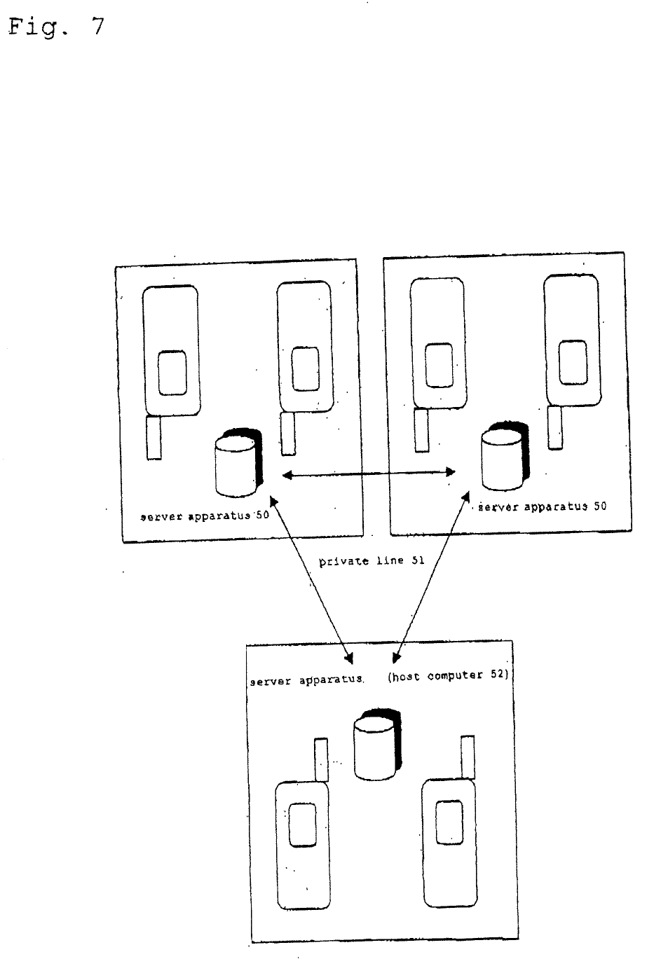

For example, in the case of a preparatory school having branch campuses all over the country, it is possible to connect server apparatus in every campus through the private line. FIG. 7 is a diagram illustrating a state wherein a plurality of server apparatuses are connected by private lines, etc. In this figure, numeral 50s are server apparatus, which are connected by a private line 51. Numeral 52 is a host computer which is capable of collecting information data gathered by each server apparatus 50 and finally adding them up. Needless to say, it becomes possible fox each server apparatus to add up information data received in the school building wherein said server apparatus itself is located.

In the present embodiment, the telecommunication network is formed in a predetermined area using an ordinary telephone line, but not limited to said line, and it is possible to use portable phones for transmission/reception information data in the frequency band usable only in a limited area. In this case, it is possible to restrict the transmission/reception of information data to its exchange only in the limited area by installing a switching circuit for changing and switching the frequency band with that used in the general telephone line, and altering the frequency band using said switching circuit. This alteration of frequency band by the switching circuit can be performed according to a predetermined program storing the operation procedure for switching the frequency band used for transmission/reception information data, and the operation flow for implementing the switching circuit by the order of the control unit, in case of inputting according to this operation procedure. This predetermined program may be previously stored in the nonvolatile memory and ROM of portable phones. Practical flow in the case where electric waves in different frequency bands are used will be briefly described. First, it is confirmed whether the frequency band of a portable phone is switched to the one used in the limited area using a display screen, etc., and, in the case where it is the frequency band used by a general telephone line in the predetermined area, it is switched by the operation at the operation unit according to a predetermined program, In the case where information data is provided from the server apparatus, the portable phone is noticed of the signal of information arrival by music, alarm, etc. through a loudspeaker. That information data is then once stored in the nonvolatile memory, and displayed on the display screen as the image, such as letters, etc. by operating the operation unit. Contents of images may be displayed as questionnaires of the test held in a preparatory school and answers divided into a) through e), etc. It is possible to use about the same flow as that in the above-described embodiment in the subsequent flow.

The present embodiment was described with reference to preparatory school as an example, but is not limited to this. For example, with all organizations including educational foundation, company or religious corporation, etc. as targets it is possible to establish an information transmission and reception system for the exclusive use of a particular organization.

In this embodiment are used portable phones as the information transmission and reception apparatus, but said embodiment can be implemented using other apparatuses capable of transmission/reception information data via the telecommunication line, and it is possible to widely apply, for example, portable game machine capable of telecommunication, laptop and desktop type personal computer, telecommunication informational apparatus capable of exchanging e-mail by internet, etc., portable electronic note, etc.

As the telecommunication line in this invention, regardless whether cabled or wireless, are used, for example, the ordinary telephone line and private line.

In the present embodiment, although portable phones as the information terminal apparatus are made capable of transmitting/receiving information in a limited area, they are not limited to this type, but may be made capable of either only transmitting or receiving information corresponding to the usage. For example, in the case where only the collection of answers to questionnaires, etc. is wanted, portable phone may be made capable of only transmitting information, and in the case where mutual exchange of opinions and discussion are not required, and exchange of information with the server apparatus using information terminal apparatus are necessary, portable phone may be made capable of only receiving information.

According to the information transmission and reception system of this invention, since it becomes possible to use the information terminal apparatus carrying out the transmission/reception of information data via the telecommunication line such as an ordinary telephone line in a predetermined area as an information terminal apparatus for the exclusive use in a limited area capable of transmitting and/or receiving information data exclusively in a limited area, said system broadens the scope of application forms of communication, so that it becomes very convenient for users of information terminal apparatus, and, at the same time, it makes it easy to keep the secret concerning information data contents because the range of transmitting and/or receiving of information data is limited. For example, it also becomes possible to temporally use a portable phone, an information terminal apparatus, as an answering terminal apparatus for transmitting answers made for questionnaires as the data to the server.

Furthermore, according to the server apparatus of this invention, since said server unit makes an information terminal apparatus capable of doing the transmission and/or reception of information data via the ordinary telecommunication line in a predetermined area perform the transmission and/or reception of information data by another telecommunication network when said terminal apparatus is located in another limited area, it becomes possible to realize the expansion in the scope of application forms of information terminal apparatus, and perform the exchange of information data without the use of a separate information terminal apparatus. In addition, in the case where information data are received from a plurality of information terminal apparatuses, stored and processed, it becomes possible to subsequently process accumulated data including the adding up of said data.

1. An information transmission and reception system using portable phones as an information transmission and reception apparatus carrying out the transmission and reception of information data via an ordinary telephone line in a predetermined area, wherein
said system employs said portable phones as an information terminal apparatus capable of transmitting and/or receiving information data exclusively used in a limited area different from said predetermined area.

2. An information transmission and reception system using an information terminal apparatus capable of transmitting and receiving information data by a telecommunication network utilizing an ordinary telecommunication line in a predetermined area, wherein
said system is provided with a server apparatus performing the transmission and/or reception of information data for said information terminal apparatus located in a limited area different from said predetermined area via a telecommunication network for the exclusive use in said limited area which is different from the said telecommunication network.

3. An information transmission and reception system according to claim 2, wherein
said system uses portable phones as said information terminal apparatus to make the communication connection with said server apparatus in said limited area using a number different from the telephone number used in said predetermined area.

4. A server apparatus capable of transmitting and/or receiving information data via a telecommunication network using a telecommunication line in a predetermined area, and performing the transmission and/or reception of information data for information terminal apparatuses located in a limited area different from said predetermined area via a telecommunication network for the exclusive use in said limited area different from the aforesaid telecommunication network.

5. A server apparatus according to claim 4, wherein said server apparatus receives information data from a plurality of said information terminal apparatuses, respectively, to store and process them.
